(19) United States
(12) Patent Application Publication
(10) Pub. No.: US 2022/0075034 A1
(43) Pub. Date: Mar. 10, 2022

(54) LIDAR DEVICE AND DRIVING METHOD THEREOF

(71) Applicant: SAMSUNG ELECTRONICS CO., LTD., Suwon-si (KR)

(72) Inventors: Jungwoo KIM, Hwaseong-si (KR); Tatsuhiro OTSUKA, Suwon-si (KR); Yongchul CHO, Suwon-si (KR)

(73) Assignee: SAMSUNG ELECTRONICS CO., LTD., Suwon-si (KR)

(21) Appl. No.: 17/160,112

(22) Filed: Jan. 27, 2021

(30) Foreign Application Priority Data
Sep. 4, 2020 (KR) 10-2020-0113217

(51) Int. Cl. G01S 7/481; G01S 17/931; G01S 7/484

(52) U.S. Cl. CPC G01S 7/4817; G01S 7/484; G01S 17/931

(57) ABSTRACT

Provided are a light detection and ranging (LiDAR) device and a driving method of a LiDAR. Device. The driving method including performing a vertical scanning with respect to a subject region by using a first light reflector, performing a horizontal scanning of the subject region by using a second light reflector, and controlling a driving current applied to the first light reflector in real time during a horizontal scanning process when the vertical scanning is performed at a height different from a reference height, wherein the first light reflector has a first axis, wherein the second light reflector has a second axis, and wherein the first axis and the second axis are spaced apart from each other and perpendicular to each other.

### CROSS-REFERENCE TO RELATED APPLICATION

This application claims priority to Korean Patent Application No. 10-2020-0113217, filed on Sep. 4, 2020 in the Korean Intellectual Property Office, the disclosure of which is incorporated by reference herein in its entirety.

### BACKGROUND

### 1. Field

Example embodiments consistent with the present disclosure relate to three-dimensional (3D) laser scanning, and more particularly, to a light detection and ranging (LiDAR) device and a driving method thereof.

### 2. Description of Related Art

LiDAR is one of the distance measuring techniques with respect to a subject in a three-dimensional (3D) space. Recently, interest in autonomous mobile devices, such as autonomous vehicles or robots has increased along with research on related fields. In some fields, various devices related to autonomous driving have been introduced.

LiDAR may operate like an eye, and thus, may be an essential element in an autonomous vehicle. Accordingly, various LiDAR devices have been introduced so far, but they have not reached a performance level to ensure sufficient autonomous driving.

### SUMMARY

One or more example embodiments provide driving methods of a LiDAR device to eliminate or minimize defects occurring in an image during a scanning process.

One or more example embodiments also provide LiDAR devices using the driving method thereof.

Additional aspects will be set forth in part in the description which follows and, in part, will be apparent from the description, or may be learned by practice of example embodiments.

According to an aspect of an example embodiment, there is provided a driving method of a light detection and ranging (LiDAR) device, the driving method including performing a vertical scanning with respect to a subject region by using a first light reflector, performing a horizontal scanning of the subject region by using a second light reflector, and controlling a driving current applied to the first light reflector in real time during a horizontal scanning process when the vertical scanning is performed at a height different from a reference height, wherein the first light reflector has a first axis, wherein the second light reflector has a second axis, and wherein the first axis and the second axis are spaced apart from each other and perpendicular to each other.

The controlling the driving current may be performed within a certain range of the horizontal scanning.

The performing the vertical scanning and the performing the horizontal scanning may include performing the vertical scanning and performing the horizontal scanning, respectively, by using a first light source that radiates a first light to the first light reflector.

The performing the vertical scanning and the performing the horizontal scanning may include performing the vertical scanning and performing the horizontal scanning, respectively, by using a second light source that radiates a second light to the first light reflector, the second light source being different from the first light source.

The performing the vertical scanning and the performing the horizontal scanning may include performing the vertical scanning and performing the horizontal scanning, respectively, by using a third light source radiates a third light to the first light reflector, the third light source being different from the first light source and the second light source.

The first light source, the second light source, and the third light source may be provided on a same plane.

The first light source, the second light source, and the third light source may be vertically arranged.

According to another aspect of an example embodiment, there is provided a light detection and ranging (LiDAR) device including a light source unit including a plurality of light sources, a first light reflector configured to perform a vertical scanning, the first light reflector having a first axis, and a second light reflector configured to perform a horizontal scanning, the second light reflector having a second axis that is perpendicular to the first axis.

The plurality of light sources may be provided on a same plane.

The plurality of light sources may be vertically arranged.

The plurality of light sources may be horizontally arranged.

The first light reflector may be configured to rotate around the first axis, and the second light reflector may be configured to rotate around the second axis.

The plurality of light sources may be respectively configured to emit light to a same position on the first light reflector.

The plurality of light sources may include a first light source, a second light source, and a third light source.

The first light source may be configured to emit a first light to the first light reflector based on a rotation angle of the second light reflector being in a first range, the second light source may be configured to emit a second light to the first light reflector based on the rotation angle of the second light reflector being in a second range, the third light source may be configured to emit a third light to the first light reflector based on the rotation angle of the second light reflector being in a third range, wherein the first range, the second range, and the third range are different from each other.

The second light reflector may include a reflector, a rotating shaft, and a rotating device.

The first light reflector may be configured to receive light from the light source unit and reflect the light received to the second light reflector.

The second light reflector may be configured to receive the light reflected from the first light reflector and reflect the light received to a subject.

The first light reflector may be configured to rotate with respect to the first axis to change an incident angle of the light received by the second light reflector.

According to yet another aspect of an example embodiment, there is provided a light detection and ranging (LiDAR) device including a light source unit configured to emit light, the light source unit including a plurality of light sources, a first light reflector configured to receive the light emitted from the light source unit and reflect the light, the first light reflector being configured to rotate around a first axis, and a second light reflector configured to receive the light reflected by the first light reflector and reflect the light received to a subject, the second light reflector being configured to rotate around a second axis that is perpendicular to the first axis.

### BRIEF DESCRIPTION OF THE DRAWINGS

The above and/or other aspects, features, and advantages of example embodiments will be more apparent from the following description taken in conjunction with the accompanying drawings, in which:

FIG. 1 is a cross-sectional view showing a first LiDAR device using a driving method of a LiDAR device according to an example embodiment;

FIG. 2 is a graph showing a vertical direction height difference (nonlinear characteristic) that appears in a LiDAR horizontal scanning process of the related art;

FIG. 3 is a graph showing a result of eliminating a nonlinear characteristic appearing in a horizontal scan by applying a driving method of a LiDAR device according to an example embodiment in FIG. 2;

FIG. 4 is a cross-sectional view showing a second LiDAR device according to an example embodiment; and

FIG. 5 is a plan view of the LiDAR device of FIG. 4; and

FIG. 6 is a cross-sectional view showing a third LiDAR device according to an example embodiment.

### DETAILED DESCRIPTION

Reference will now be made in detail to example embodiments of which are illustrated in the accompanying drawings, wherein like reference numerals refer to like elements throughout. In this regard, example embodiments may have different forms and should not be construed as being limited to the descriptions set forth herein. Accordingly, the example embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Hereinafter, a LiDAR device and a driving method of a LiDAR device according to an example embodiment will be described in detail with reference to the accompanying drawings. In the drawings, thicknesses of layers and regions may be exaggerated for clarity of layers and regions The example embodiments are capable of various modifications and may be embodied in many different forms. In a layer structure described below, when an element or layer is referred to as being “on” or “above” another element or layer, the element or layer may be directly on another element or layer or intervening elements or layers. The electronic device includes a semiconductor device. In the descriptions below, like reference numerals refer to like elements throughout.

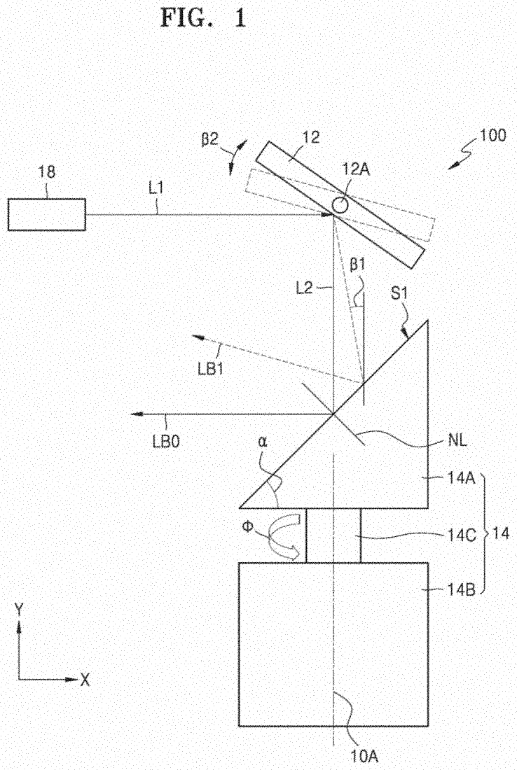

FIG. 1 shows a first LiDAR 100 according to an example embodiment.

Referring to FIG. 1, the first LiDAR device 100 includes a first light source 18, a first light reflector 12 and a second light reflector 14. The first LiDAR device 100 may further include other members besides above. The first light source 18 may include a light source that emits a laser. In one example, the first light source 18 may be a semiconductor-based laser device, and may include, for example, a laser diode. The first light reflector 12 may reflect light L1 emitted from the first light source 18 towards the second light reflector 14. The first light reflector 12 may be a rotating mirror that reflects the light L1 incident from the first light source 18 towards the second light reflector 14 or may include the rotating mirror. The first light reflector 12 may be rotated about a first axis 12A. The first axis 12A may be parallel to a Z axis. The light L1 incident on the first light reflector 12 from the first light source 18 may be perpendicular to the first axis 12A. The first axis 12A and the first light source 18 may be arranged in the same plane, or may not be arranged in the same plane. The first light reflector 12 may be rotated 360° around the first axis 12A, but may be rotated within an angular range less than 360°. The first light reflector 12 may be rotated in an angular range so that the first LiDAR device 100 performs a vertical scan. In an example, a range of total rotation angle of the first light reflector 12 may be an acute angle. The second light reflector 14 may include a reflector 14A having a light reflecting surface S1 and a rotating mechanism 14B for rotating the reflector 14A. The reflector 14A and the rotating mechanism 14B may be connected by a rotating shaft 14C. The rotating mechanism 14B, the rotating shaft 14C, and the reflector 14A may be vertically stacked in a direction parallel to the Y-axis. The reflector 14A may be a triangular mirror having the light reflection surface S1 as one surface. The light reflection surface S1 may be a surface inclined at a given angle α with respect to a bottom surface of the reflector 14A. In an example, the given angle α may be about 45°. The bottom surface of the reflector 14A may be parallel to a plane formed by an X-axis and the Z-axis, that is, an X-Z plane. The rotating mechanism 14B may be a device for generating a rotational force to rotate the rotating shaft 14C in a given direction or in an opposite direction or may include the device for generating a rotational force. In an example, the rotating mechanism 14B may include a motor to generate the rotational force. A rotational force generated by the rotating mechanism 14B is transmitted to the reflector 14A through the rotating shaft 14C. Accordingly, the reflector 14A rotates horizontally, for example, rotates around a Y-axis in the X-Z plane. The rotating shaft 14C may be rotated about a second axis 10A parallel to the Y-axis. The second axis 10A, which is a single axis, may be perpendicular to the first axis 12A, which is a single axis. The first light reflector 12 may be disposed directly above the reflector 14A while satisfying an arrangement relationship of the axis, and the first axis 12A may meet an extension line of the second axis 10A. Since the reflector 14A is rotated within the X-Z plane, light reflected from the light reflecting surface S1, for example, light LB0 and light LB1 may be horizontally scanned. Accordingly, a width of a horizontally scanned area may be increased or decreased in proportion to a rotation angle of the reflector 14A, that is, the rotation angle ϕ of the rotating shaft 14C. As the rotation range of the reflector 14A increases, the horizontal scan region increases. The first light reflector 12 is responsible for vertical scanning, and a region to be vertically scanned according to a rotation angle may increase or decrease. As a result, a three-dimensional scan may be possible by operating the first light reflector 12 and the second light reflector 14 together. The first LiDAR device 100 performs light radiation or light scan with respect to an area in which a subject exists and receives light reflected from the region where the subject exists, and may include an optical receiver.

Next, in the first LiDAR device 100, a light radiation or light scan process with respect to a region where a subject exists will be described.

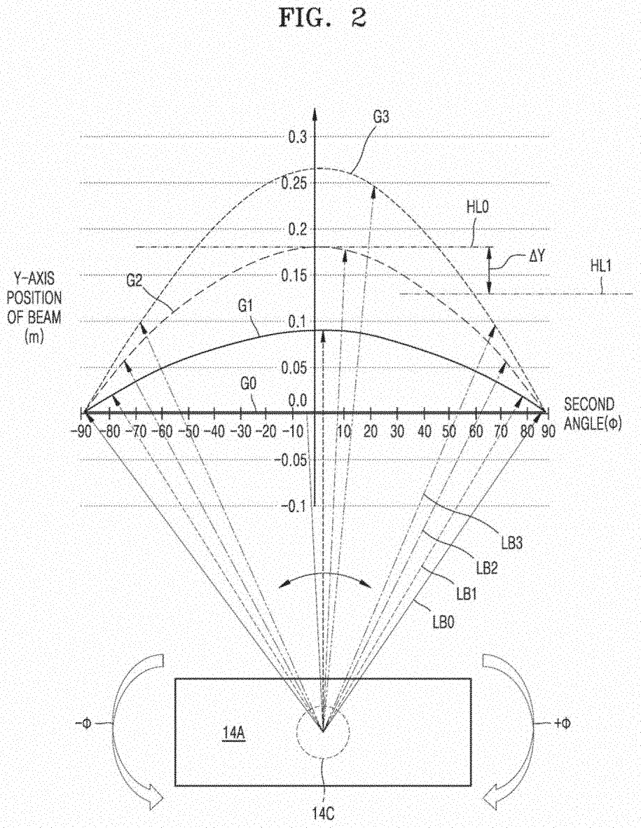

Light L2 reflected from the first light reflector 12 and incident on the reflector 14A of the second light reflector 14 may be reflected from the light reflective surface S1 of the reflector 14A, and may be reflected in a direction different from an incident direction according to the light reflection condition. A height, that is, a scanning height at which light such as, for example, first light LB0 and second light LB1 reflected by the light reflective surface S1 is radiated to a region where the subject exists which may be a subject region varies depending on an angle of incidence of the light L2 incident on the light reflective surface S1. For example, the Y-axis direction height (position) at which light is scanned in the subject region varies according to a first angle β1 between the light L2 incident on the light reflective surface S1 and the second axis 10A. For example, when the light L2 is incident on the light reflective surface S1 parallel to the second axis 10A, that is, when the first angle β1 is 0°, the light LB0 reflected from the light reflection surface S1 is radiated in parallel to the X-Z plane or a bottom surface of the reflector 14A. When the first angle β1 is 0°, the height (position) in the Y-axis direction at which the first light LB0 reflected from the light reflection surface S1 is scanned to the subject region may be a reference height. When the first angle β is 0°, the light L2 incident on the reflector 14A is parallel to the second axis 10A. In this a case, when the reflector 14A is rotated at a second angle ϕ, the first light LB0 is scanned horizontally in the subject region as much as the rotation range of the reflector 14A, and the height that is scanned may be the same in the entire rotation range. That is, the height (position) in the Y-axis direction scanned by the first light LB0 over the entire rotation range is the same as the reference height. The first graph G0 of FIG. 2 shows such a case. When the first angle β1 is not 0°, that is, when the light L2 incident on the light reflection surface S1 is inclined with respect to the second axis 10A, the direction of the second light LB1 reflected from the light reflection surface S1 is not parallel to the first light LB0. The second light LB1 proceeds in a direction higher than the first light LB0, that is, an upward direction with respect to the first light LB0. Accordingly, the height (position) in the Y-axis direction at which the second light LB1 is scanned in the subject region is higher than the reference height. On the other hand, when the reflected second light LB1 proceeds in a direction lower than the first light LB0, that is, a downward direction with respect to the first light LB0, the height (position) in the Y-axis direction at which the second light L1 is scanned in the subject region may be lower than the reference height. When the second angle ϕ of the reflector 14A is 0° and the traveling direction of the second light LB1 is upward with respect to the first light LB0, the height (position) in the Y-axis direction at which the second light L1 is scanned in the subject region may be a first height. The first height is higher than the reference height. When the second angle ϕ of the reflector 14A is not 0°, that is, the reflector 14A is rotated, the reflected second light LB1 may also be scanned over the entire rotation range of the reflector 14A similar to the first light LB0. The height (position) in the Y-axis direction at which the second light L1 is scanned may vary according to the rotation angle of the reflector 14A. For example, when a rotation angle of the reflector 14A increases, that is, when the second angle ϕ increases, the height in the Y-axis direction at which the second light LB1 is scanned in the subject region may be lower than the first height, and, as the rotation angle increases, the scan height may further be lowered. In other words, when the first angle β1 is not 0°, the horizontal scan height (position) of the second light LB1 is lower than the first height as the second angle ϕ increases, and as the second angle ϕ increases, the horizontal scan height non-linearly decreases. Second to fourth graphs G1, G2, and G3 of FIG. 2 illustrate the above cases as an example.

In FIG. 2, the horizontal axis represents the second angle ϕ. The vertical axis represents the scan height (position) (m) of the light beam in the Y-axis direction. As described above, the first graph G0 shows a change in the scan height in the Y-axis direction according to the second angle ϕ when the first angle β1 is 0°. The second to fourth graphs G1, G2, and G3 show changes in the Y-axis direction scan height according to the second angle ϕ when the first angle β1 is not 0°. The second graph G1 shows the change in the Y-axis direction scan height according to the second angle ϕ when the first angle β1 is 5°. The third graph G2 shows the change in the Y-axis direction scan height according to the second angle ϕ when the first angle β1 is 10°. The fourth graph G3 shows the change in the Y-axis direction scan height according to the second angle ϕ when the first angle β1 is 15°. Reference numeral LB1 denotes light reflected from the second light reflector 14 to the subject region, that is, light for scanning the subject region when the first angle β1 is 5°. Reference numeral LB2 denotes light reflected from the second light reflector 14 to the subject region when the first angle β1 is 10°. Reference numeral LB3 denotes light reflected from the second light reflector 14 to the subject region when the first angle β1 is 15°.

Referring to the second to fourth graphs G1, G2, and G3 of FIG. 2, when the first angle β1 is not 0° and the second light reflector 14 is rotated left and right with the second angle ϕ, the scan height in the Y-axis direction in the subject region decreases as the second angle ϕ increases. As an example, referring to the third graph G2, a first scan height HL0 in the Y-axis direction when the first angle β1 is about 10° and the second angle ϕ is 0° is different from a second scan height HL1 in the Y-axis direction when the first angle β1 is about 10° and the second angle ϕ is about 40°, and a height difference ΔY occurs between the first and second scan heights HL0 and HL1. As described above, when a scan height in the Y-axis direction of the subject region varies according to the second angle ϕ, a defect, for example, distortion, may occur in a sensed image of the subject region.

The defect may be eliminated or minimized by correcting the height difference ΔY.

The scan height Ry in the Y-axis direction in the subject region may be determined by Equation 1 below.

Ry=cos(2α)cos β1+sin(2α)sin β1conϕ <Equation 1>

Next, an example for correcting the height difference ΔY based on Equation 1 will be described.

As an example, in order to resolve a height difference ΔY that occurs when the first angle β1 is not 0° and the second angle ϕ is about 40°, the first light reflector 12 is rotated by a third angle β2 from the second angle ϕ at which the height difference ΔY occurs. An incident angle or the first angle β1 of the light L2 incident on the reflector 14A of the second light reflector 14 varies according to the rotation of the first light reflector 12. Accordingly, at the time when the height difference ΔY occurs, the third angle β2 of the first light reflector 12 may be actively controlled until the height difference ΔY is reduced or removed. The first light reflector 12 may be an electrically operated reflective mirror. Accordingly, the third angle β2 of the first light reflector 12 may be controlled by controlling a driving current applied to the first light reflector 12. In an example, the control of the third angle β2 of the first light reflector 12 may be performed until the height difference ΔY is removed. In another example, the third angle β2 of the first light reflector 12 may be controlled until the height difference ΔY is a minimum value. At this point, the minimum value may be a value when the height difference ΔY is less than 10% of the reference height based on the reference height, and in another example, may be a value when the height difference ΔY is less than 5%. The minimum boundary or range may differ depending on LiDAR. When the height difference ΔY is 0, as well as when the height difference ΔY is minimum, the height of the horizontal scan may be regarded as the same. The driving of the first light reflector 12 may be performed with respect to a case that a first angle β1 is not 0° and a second angle ϕ is in a given range greater than 0°. The given range of the second angle ϕ may be ±90° or less, in one example, ±70° or less, in another example ±60° or less, and in another example ±50° or less.

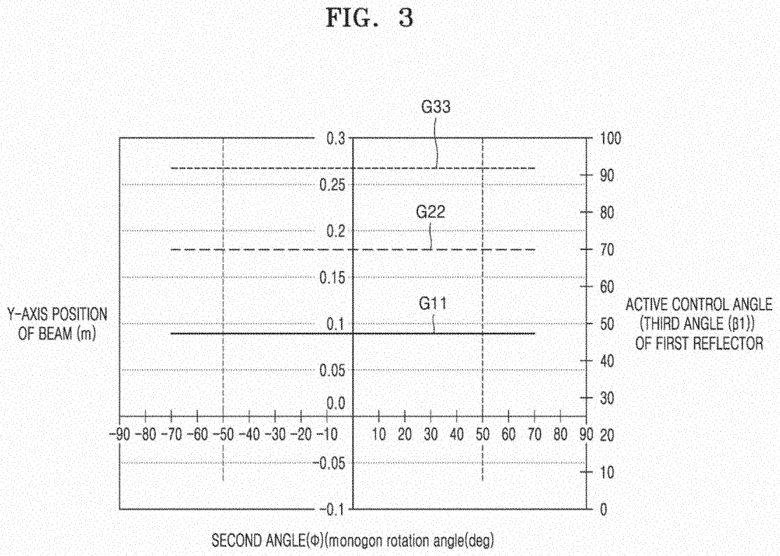

Through the driving of the first light reflector 12, the second to fourth graphs G1, G2, and G3 of FIG. 2 may have the same height in the Y-axis direction as shown in second to fourth graphs G11, G22, and G33 of FIG. 3 with respect to the horizontal scan of the given range, respectively. That is, a height difference ΔY occurring in a given range in which the second angle ϕ is greater than 0° is corrected. Accordingly, image distortion on the subject region may be eliminated or minimized during a driving process of the LiDAR. Therefore, when the driving method according to an example embodiment is used, an image of a region to be irradiated, that is, a subject region, may be obtained without a given defect such as, for example, distortion or an image in which given defects are minimized may be obtained, and thus, the reliability of the acquired image may be increased. Accordingly, when the images are used in an autonomous vehicle or an autonomous mobile device such as, for example, a robot, etc., an operation of a corresponding vehicle or a mobile device may be more accurate, and thus, the operation reliability may be increased.

In the driving method described above, when the second angle ϕ is outside of a given range, the height difference ΔY may appear again. For example, when the height difference ΔY occurs as the second angle ϕ is greater than ±50°, an additional LiDAR device may be used for a range where the second angle ϕ is greater than ±50°, and the driving method described above according to FIG. 1 may be applied to the additional LiDAR device. However, this method may not be economical due to the increased number of LiDAR devices required. According to example embodiments, a plurality of light sources may be provided in one LiDAR device, and certain light sources determined among the plurality of light sources may be used when the second angle ϕ is outside of a given range.

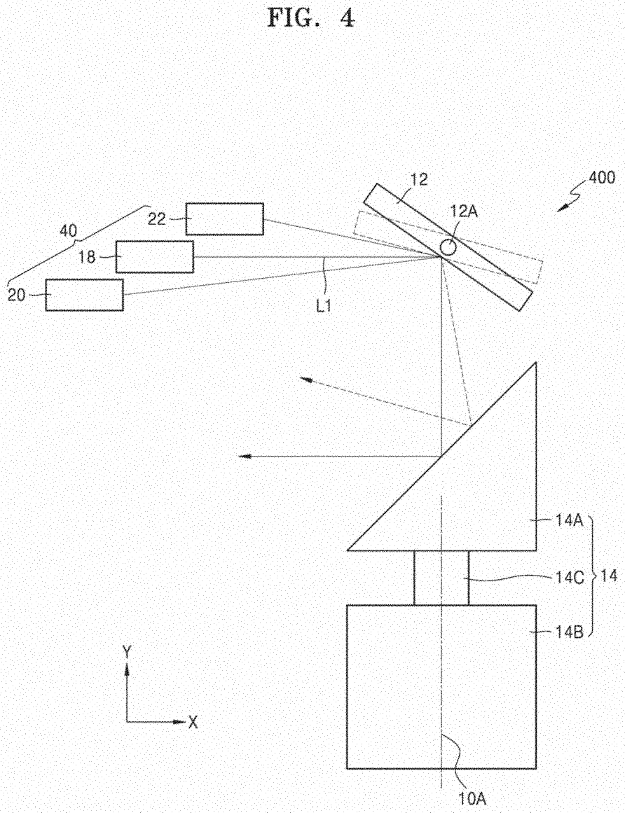

FIG. 4 shows a second LiDAR device 400 according to an example embodiment. In the description of FIG. 4, only portions different from the description of FIG. 1 will be described, and the same reference numerals refer to the same members, and the description of the corresponding members will be omitted.

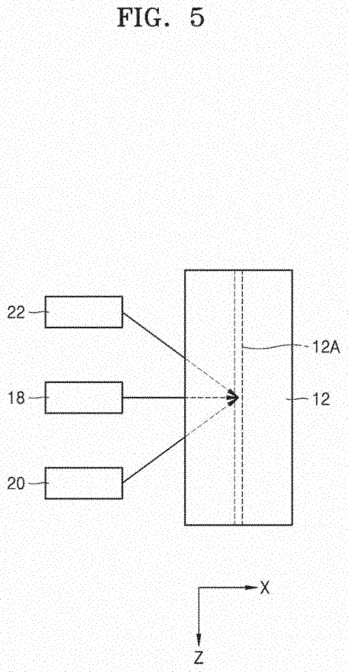

Referring to FIG. 4, the second LiDAR device 400 includes a light source unit 40, the first light reflector 12 and the second light reflector 14. The light source unit 40 includes a plurality of light sources, for example, first light source 18, a second light source 20, and a third light source 22. The first to third light sources 18, 20, and 22 are disposed horizontally as shown in FIG. 5. All of the first to third light sources 18, 20, and 22 may be disposed on the same plane such as the X-Z plane. Light L1 emitted from the first to third light sources 18, 20, and 22 may be incident on the same position of the first light reflector 12. The first light source 18 may be used when a second angle ϕ is in a first rotation range. The second light source 20 may be used when the second angle ϕ is in a second rotation range. The third light source 22 may be used when the second angle ϕ is in a third rotation range. The first to third rotation ranges may be different from each other. The first rotation range may be, for example, greater than 0° and less than ±50°. The second rotation range may be greater than the first rotation range, and the third rotation range may be greater than the second rotation range.

FIG. 5 is a plan view of the LiDAR device in FIG. 4.

FIG. 5 illustrates that the first to third light sources 18, 20, and 22 radiate light to a same position of the first light reflector 12 that is on the first axis 12A.

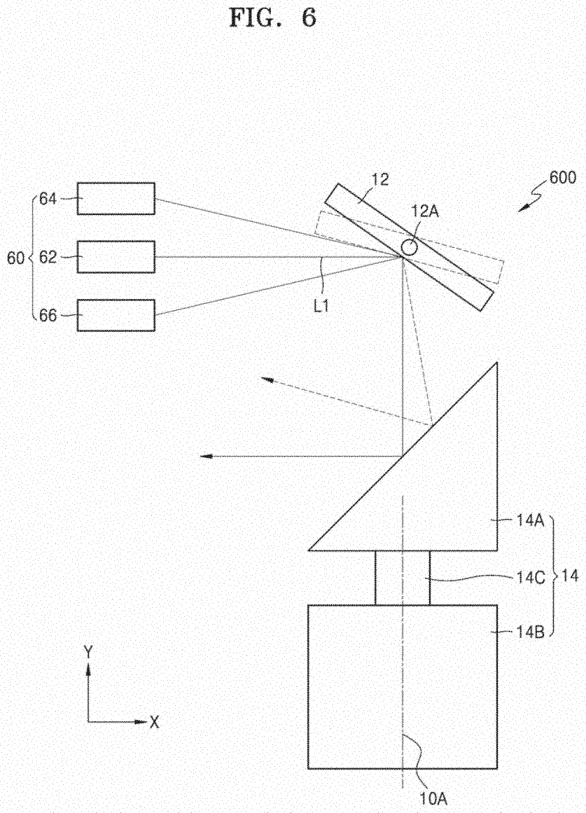

FIG. 6 is a cross-sectional view showing a third LiDAR device 600 according to an example embodiment. In the description of FIG. 6, only portions different from the description of FIG. 1 will be described, and like reference numerals denote like members and the description thereof will be omitted.

Referring to FIG. 6, the third LiDAR device 600 includes a light source unit 60, the first light reflector 12, and the light second reflector 14. The light source unit 60 includes a plurality of light sources, for example, a first light source 62, a second light source 64, and a third light source 66. The first to third light sources 62, 64, 66 are vertically arranged in a Y-axis direction. Light L1 emitted from the first to third light sources 62, 64, and 66 may be incident on the same position of the first light reflector 12. The first light source 62 may be used when a second angle ϕ is in a first rotation range. The second light source 64 may be used when the second angle ϕ is in a second rotation range. The third light source 66 may be used when the second angle ϕ is in a third rotation range. The first to third rotation ranges may be different from each other. The first rotation range may be, for example, greater than 0° and less than ±50°. The second rotation range may be greater than the first rotation range, and the third rotation range may be greater than the second rotation range.

The disclosed driving method of LiDAR device may correct a height difference in real time during a horizontal scanning process performed at a given vertical scan angle. Accordingly, defects such as, for example, distortion in an image obtained from a region to which a beam is radiated may be removed or minimized. Accordingly, the accuracy and reliability of an image of a subject region obtained by radiating a beam may be improved. Therefore, when the disclosed driving method is applied to a device such as, for example, an autonomous vehicle, an autonomous mobile device, a robot, etc., the accuracy and reliability of an operation of the corresponding device may be increased.

It should be understood that example embodiments described herein should be considered in a descriptive sense only and not for purposes of limitation. Descriptions of features or aspects within each example embodiment should typically be considered as available for other similar features or aspects in other embodiments.

While example embodiments have been described with reference to the figures, it will be understood by those of ordinary skill in the art that various changes in form and details may be made therein without departing from the spirit and scope as defined by the following claims.

What is claimed is:

1. A driving method of a light detection and ranging (LiDAR) device, the driving method comprising:
performing a vertical scanning with respect to a subject region by using a first light reflector;
performing a horizontal scanning of the subject region by using a second light reflector; and
controlling a driving current applied to the first light reflector in real time during a horizontal scanning process when the vertical scanning is performed at a height different from a reference height,
wherein the first light reflector has a first axis,
wherein the second light reflector has a second axis, and
wherein the first axis and the second axis are spaced apart from each other and perpendicular to each other.

2. The driving method of claim 1, wherein the controlling the driving current is performed within a certain range of the horizontal scanning.

3. The driving method of claim 1, wherein the performing the vertical scanning and the performing the horizontal scanning comprise performing the vertical scanning and performing the horizontal scanning, respectively, by using a first light source that radiates a first light to the first light reflector.

4. The driving method of claim 3, wherein the performing the vertical scanning and the performing the horizontal scanning comprise performing the vertical scanning and performing the horizontal scanning, respectively, by using a second light source that radiates a second light to the first light reflector, the second light source being different from the first light source.

5. The driving method of claim 4, wherein the performing the vertical scanning and the performing the horizontal scanning further comprise performing the vertical scanning and performing the horizontal scanning, respectively, by using a third light source that radiates a third light to the first light reflector, the third light source being different from the first light source and the second light source.

6. The driving method of claim 5, wherein the first light source, the second light source, and the third light source are provided on a same plane.

7. The driving method of claim 5, wherein the first light source, the second light source, and the third light source are vertically arranged.

8. A light detection and ranging (LiDAR) device comprising:
a light source unit comprising a plurality of light sources;
a first light reflector configured to perform a vertical scanning, the first light reflector having a first axis; and
a second light reflector configured to perform a horizontal scanning, the second light reflector having a second axis that is perpendicular to the first axis.

9. The LiDAR device of claim 8, wherein the plurality of light sources are provided on a same plane.

10. The LiDAR device of claim 8, wherein the plurality of light sources are vertically arranged.

11. The LiDAR device of claim 9, wherein the plurality of light sources are horizontally arranged.

12. The LiDAR device of claim 8, wherein the first light reflector is configured to rotate around the first axis, and
wherein the second light reflector is configured to rotate around the second axis.

13. The LiDAR device of claim 8, wherein the plurality of light sources are respectively configured to emit light to a same position on the first light reflector.

14. The LiDAR device of claim 12, wherein the plurality of light sources comprises a first light source, a second light source, and a third light source.

15. The LiDAR device of claim 14, wherein the first light source is configured to emit a first light to the first light reflector based on a rotation angle of the second light reflector being in a first range,
wherein the second light source is configured to emit a second light to the first light reflector based on the rotation angle of the second light reflector being in a second range,
wherein the third light source is configured to emit a third light to the first light reflector based on the rotation angle of the second light reflector being in a third range, and
wherein the first range, the second range, and the third range are different from each other.

16. The LiDAR device of claim 8, wherein the second light reflector comprises a reflector, a rotating shaft, and a rotating device.

17. The LiDAR device of claim 8, wherein the first light reflector is configured to receive light from the light source unit and reflect the light received to the second light reflector.

18. The LiDAR device of claim 17, wherein the second light reflector is configured to receive the light reflected from the first light reflector and reflect the light received to a subject.

19. The LiDAR device of claim 18, wherein the first light reflector is configured to rotate with respect to the first axis to change an incident angle of the light received by the second light reflector.

20. A light detection and ranging (LiDAR) device comprising:
a light source unit configured to emit light, the light source unit comprising a plurality of light sources;
a first light reflector configured to receive the light emitted from the light source unit and reflect the light, the first light reflector being configured to rotate around a first axis; and
a second light reflector configured to receive the light reflected by the first light reflector and reflect the light received to a subject, the second light reflector being configured to rotate around a second axis that is perpendicular to the first axis.
